(19) United States
(12) Patent Application Publication
(10) Pub. No.: US 2008/0315662 A1
(43) Pub. Date: Dec. 25, 2008

(54) Arrester Device For an Adjustable Vehicle Seat

(75) Inventors: Wolfgang Suck, Coburg (DE); Matthias Baudler, Coburg (DE)

Correspondence Address: CHRISTIE, PARKER & HALE, LLP, PO BOX 7068, PASADENA, CA, 91109-7068, US

(73) Assignee: BROSE FAHRZEUGTEILE GMBH & CO. KG, COBURG, Coburg (DE)

(21) Appl. No.: 11/885,480

(22) PCT Filed: Feb. 22, 2006
(86) PCT No.: PCT/DE06/00339

§ 371 Date: Aug. 30, 2007

(30) Foreign Application Priority Data
Mar. 2, 2005 (DE) 20 2005 003 626.9

(51) Int. Cl. B60N 2/08

(52) U.S. Cl. 297/463.1

(57) ABSTRACT

An arrester device for an adjustable vehicle seat with at least one locking rail running parallel to an adjusting direction and having periodically arranged locking lugs and locking openings includes a locking unit which includes a plurality of locking pins with a cylindrical shaft. The locking pins are guided independently of one another in a guide device in a locking direction, are displaceable in the locking openings and are pretensioned in the locking direction. The locking pins have a circumferential thread structure at least on the portion of the cylindrical shaft thereof running through a guide portion of the guide device.

### CROSS-REFERENCE TO A RELATED APPLICATION

This application is a National Phase Patent Application of International Patent Application No. PCT/DE2006/000339, filed on Feb. 22, 2006, which claims priority of German Patent Application Number 20 2005 003 626.9, filed on Mar. 02, 2005.

### BACKGROUND

The invention relates to an arrester device for an adjustable vehicle seat.

Such an arrester device serves to block an adjusted position, moved into previously by means of a suitable adjusting device, of two seat elements of a vehicle seat which may be moved relative to one another, in particular with a longitudinal guide rail for adjusting the seating position in the longitudinal direction of the vehicle. In this connection, one rail of the longitudinal guide rail is connected to the locking rail and the other rail of the longitudinal guide rail is connected to a locking device of the arrester device. The arrester device may, however, also be used for blocking other adjusting devices with two sub-assemblies which may be moved relative to one another, in particular which may be adjusted relative to one another.

A blocking device of a longitudinal adjusting device of a motor vehicle seat is known from DE 102 42 825 A1, with a locking strip which comprises periodically arranged locking openings and locking lugs, a base rail associated with the longitudinal adjusting device and a locking unit, which is also associated with a seat rail of the longitudinal adjusting device. The locking unit comprises locking pins which may be adjusted in locking openings independently of one another and unlocked together, and which are arranged in a guide part which comprises a pin bore for each locking pin. In order to prevent, in the event of loading caused by an accident, the locking pins being pushed up out of their blocking position, the locking pins comprise a tapered groove region located in the vicinity of a lower end of the associated pin bore and denoted as a crash groove or fluting, with one or more individual grooves arranged parallel to one another. Said individual grooves counteract the pushing up of the locking pins out of the locking position, where there is the possibility of interlocked and clutched engagement, as soon as the locking pins are bent outward at the crash grooves or fluting serving as set deformation points, as a result of an accident.

Due to haptics, when actuating the locking pins the problem also exists that the locking pins are only able to be released from the blocking by increased expenditure of force and/or said locking pins jam or interlock.

Such jamming or interlocking of the blocking pins or locking pins, in particular with steel guides used for arrester devices of this type, may result from burrs or rough surfaces on the portion of the shaft of the blocking pins or locking pins guided in the guide device and/or on the inner surface of the guide bores or guide channels.

### SUMMARY

It is, therefore, the object of the present invention to provide an arrester device of the aforementioned type, in which both jamming or interlocking of the locking pins as well as inadvertent unlocking of the locking pins from the locking rail is avoided, in particular in the event of an accident.

By the arrangement of a circumferential thread structure at least on the portion of the cylindrical shaft thereof running through a guide portion of the guide device, jamming or interlocking of the locking pins as a result of burrs or rough surfaces is substantially avoided and at the same time it is ensured that by the self-locking effect of the circumferential thread structure the locking pins engaged in the locking rails, in particular in the event of an accident, do not inadvertently become unlocked from the locking rails.

In one exemplary embodiment the guide portion of the guide device is arranged adjacent to the locking rail and comprises guide bores or guide channels, through which the portion of the shaft of the locking pins provided with the thread structure is guided.

By the assignment of the portion of the shaft of the locking pins provided with the thread structure, to a guide portion of the guide device adjacent to the locking rail, in particular with multipart guide portions of the guide device, the greatest possible effect is achieved when avoiding jamming or interlocking of the locking pins and the self-locking action of the circumferential thread structure remaining in this guide portion when the locking pins are engaged in the locking rail is optimally used.

To achieve mobility of the locking pins in their entire movement range inside the guide device, without interlocking and jamming, the portion of the shaft of a locking pin provided with the thread structure engaged in a locking opening, is located in the guide bore or in the guide channel and in the portion between the guide bore or the guide channel and the locking rail.

If the locking pins comprise at the ends thereof facing the locking rail a conically extending portion or frustoconical portion, on which the locking pins are able to slide into a locking opening, the portion of the shaft provided with the thread structure is preferably directly attached to the conically extending portion or frustoconical portion.

The advantages associated with the use of the solution according to the invention may exemplary also be used with such locking pins which, for achieving reliable, low-cost compensation of the tolerances occurring in the arrester device and a low space requirement on the ends of the conically extending portion or frustoconical portion of the shaft facing the locking rail, additionally comprise an insertion bevel on which the locking pins are able to slide into a locking opening so that two locking pins are always supported in the opposing direction on a locking lug.

In one exemplary embodiment the thread structure between the conically extending portion or frustoconical portion of the shaft of the locking pins and a support of the locking pins is configured for a preloading spring such that the entire portion of the shaft of the locking pins guided inside the guide device when locking and unlocking the locking pins, is provided with the thread structure.

For assisting the self-locking effect of the portion of the shaft provided with the thread structure, the locking pins are guided with minimal clearance in the guide bores or guide channels of the guide portion of the guide device arranged adjacent to the locking rail and the thread structure is formed from a circumferential fine-pitch thread.

By the design of the thread structure as a circumferential fine-pitch thread, both a movement of the locking pins which is substantially free of interlocking and jamming, and an accurate guidance of the threaded pins in the guide bores or guide channels is ensured and the self-locking action of the thread structure is ensured for the locking pins.

For further structuring, the thread structure of the shaft of the locking pins may be provided with additional grooves extending in the longitudinal direction of the shaft, parallel or diagonal to the shaft axis, and also provided periodically.

### BRIEF DESCRIPTION OF THE DRAWING

FIG. 1 is a longitudinal section view of the arrester device.

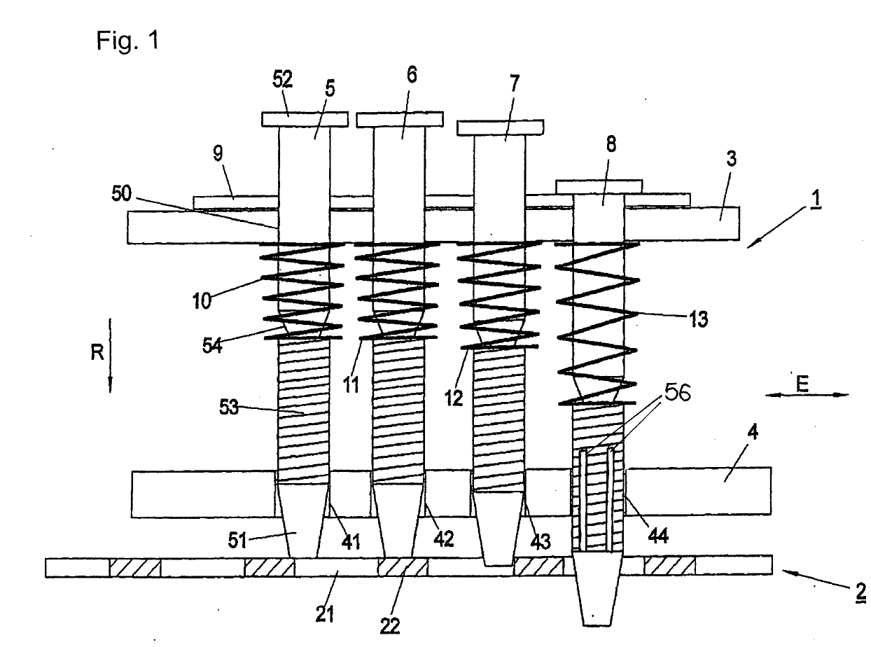

The idea underlying the invention is to be described in more detail with reference to the only FIGURE of the drawings, in which a longitudinal section through an arrester device is shown with a locking rail and a locking unit associated with the locking rail.

### DETAILED DESCRIPTION

The arrester device shown in the FIGURE comprises a locking unit 1 which, for example, is associated with the upper rail of a longitudinal seat adjuster and is rigidly connected thereto, as well as a locking rail 2 which accordingly is associated with the lower rail of the longitudinal seat adjuster and is rigidly connected thereto. The locking rail 2 contains a plurality of periodically arranged locking openings 21 which are separated from one another by locking lugs 22.

The locking unit 1 arranged above the locking rail 2 comprises a plurality of, in the present embodiment four, locking pins 5, 6, 7, 8 which are arranged at a uniform distance from one another, the distance of the central axes of adjacent locking pins 5, 6, 7, 8 being smaller than the periodic spacing between the locking opening 21 and locking lugs 22 of the locking rail 2. The locking pins 5 to 8 comprise a cylindrical shaft 50 which is terminated at the upper end thereof by a shoulder 52 and at its lower end merges into a conical portion or frustoconical portion 51.

The shafts 50 of the locking pins 5, 6, 7, 8 are movably guided in an upper guide 3 and a lower guide 4 of a guide device in the locking direction R of the locking pins 5, 6, 7, 8, a number of guide bores or guide channels 41, 42, 43, 44 corresponding to the number of locking pins 5, 6, 7, 8 being provided as guide means in the lower guide 4 and in which the shafts 50 of the locking pins 5, 6, 7, 8 are accurately guided.

Between the upper guide 3 and a chamfer 54 of the locking pins 5, 6, 7, 8 compression springs 10, 11, 12, 13 are arranged which pretension the locking pins 5, 6, 7, 8 associated with the locking openings 21 of the locking rail 2 in the direction of the locking openings 21 in the locking direction R.

Between the upper shoulder 52 of the locking pins 5 to 8 and the upper guide 3 of the guide device an unlocking rail 9 is arranged which, with a movement counter to the locking direction R, pulls the locking pins 5 to 8 located in a locking position out of the interlocking with the locking rail 2, so that the parts of the vehicle seat which may be adjusted relative to one another are released for an adjusting process. At the same time, the unlocking rail 9 acts on all locking pins 5 to 8 together, but only moves the locking pins 5 to 8 which are located in a locked position into the release position.

In the locked state shown in the FIGURE, the locking pin 8 is located in a locking opening 21, whilst the locking pin 7 is supported with one flank of its conically extending portion or frustoconical portion 51 of the shaft 50 or an insertion bevel attached thereto on the inside of a locking lug 22 of the locking rail 2. In contrast, as a result of the spring biasing, the locking pins 5 and 6 are located with the front face of their conically extending portion or frustoconical portion 51 on the upper face of two adjacent locking lugs 22.

In the schematic representation of the FIGURE a slight movement of the arrester device might be present in the adjusting direction or locking direction E which, however, may be avoided by conically extending portions or frustoconical portions 51 of the locking pins 5 to 8 adjacent to different faces of the catches 22 of the locking rail 2.

Examples for an engagement without clearance of the locking pins 5 to 8 in the adjusting direction or locking direction E in the locking rail 2 may be seen from DE 299 10 720 U1. In this known arrangement, the angle of inclination of the conically extending portions or frustoconical portions 51 of the locking pins 5 to 8 is selected such that the locking pins 5 to 8 may not be pushed out of the locking openings 21 associated therewith by very large forces acting as a result of an accident in the adjusting direction E, when the relevant locking pin 5 to 8 is not located with its shaft 50 inside the locking opening 21 but bears with the flank of the conically extending portion or frustoconical portion 51 against a locking lug 22 of the locking rail 2.

If, to unlock the arrester device, the unlocking rail 9 moves counter to the adjusting direction R, it initially bears against the shoulder 52 of the locking pin 8 and moves said shoulder counter to the locking direction R and counter to the pretensioning force of the compression spring 13 from its engagement in the locking rail 2 until the unlocking rail 9 bears against the underside of the shoulder 52 of the locking pin 7 and also pulls said shoulder out of the locked position.

As, due to the accurate guidance of the locking pins 5 to 8 in the guide bores and/or guide channels 41 to 44, this may easily result in jamming or interlocking, in particular when the flanks formed by the conical portions or frustoconical portions 51 bear against a locking lug 22 of the locking rail 2 and additional burrs are present in the guide regions, the portion of the shafts 50 of the locking pins 5 to 8 between the chamfer 54 and the start of the conical portion or frustoconical portion 51 according to the invention is provided with a thread structure 53. Said thread structure 53 prevents not only interlocking and/or jamming of the locking pins 5 to 8 in the guide bores and/or guide channels 41 to 44 of the lower guide 4 but also causes, in particular in the event of an accident, self-locking of the locking pins 5 to 8, when a locking pin 5 to 8 is engaged in a locking opening 21 of the locking rail 2 and/or bears against a locking lug 22 of the locking rail 2 with one flank of its conical portion or frustoconical portion 51.

The thread structures 53 may, for example, be configured as a fine-pitch thread, which allows a high accuracy of the locking pins 5, 6, 7, 8 in the lower guide 4 of the guide device.

For further structuring, the thread structures 53 of the locking pins 5, 6, 7, 8 may be provided with additional grooves, extending in the longitudinal direction of the shafts thereof, parallel or diagonal to the shaft axis and also provided periodically.

1-12. (canceled)

13. An arrester device for an adjustable vehicle seat having at least one locking rail running parallel to an adjusting direction with periodically arranged locking lugs and locking openings, the arrester device comprising a locking unit having a plurality of locking pins with a cylindrical shaft wherein the locking pins are guided independently of one another in a guide device in a locking direction and displaceable in the locking openings and pretensioned in said direction, and wherein each of the locking pins comprises a circumferential thread structure at least on a portion of the cylindrical shaft thereof running through a guide portion of the guide device.

14. The arrester device of claim 13, wherein the guide portion of the guide device is arranged adjacent to the locking rail and comprises one of guide bores and guide channels, wherein the portion of the shaft of the locking pins provided with the thread structure is guided through one of the guide bores and guide channels.

15. The arrester device of claim 14, wherein when the portion of the shaft of a locking pin provided with the thread structure is engaged in a locking opening, the portion is located in one of the guide bore and the guide channel and in the region between the locking rail and one of the guide bore and the guide channel.

16. The arrester device of claim 13, wherein each of the locking pins comprises at the end thereof facing the locking rail one of a conically extending portion and a frustoconical portion configured to provide sliding of the locking pin into any one of the locking openings.

17. The arrester device of claim 16, wherein the portion of the shaft provided with the thread structure is directly attached to one of the conically extending portion and the frustoconical portion.

18. The arrester device of claim 16, wherein the portion of the shaft provided with the thread structure is provided on the portion of the cylindrical shaft running through the guide portion of the guide device.

19. The arrester device of claim 16, wherein the thread structure between one of the conically extending portion and the frustoconical portion of the shaft of the locking pins and a support of the locking pins is configured for a pretensioning spring.

20. The arrester device of claim 13, wherein the locking pins are movably mounted transversely to the locking direction and wherein one of the conically extending portion and the frustoconical portion of the shaft of the locking pins comprises an insertion bevel on its end facing the locking rail configured to provide sliding of the locking pins into a locking opening of the locking rail.

21. The arrester device of claim 13, wherein the portion of the shaft of the locking pins provided with the thread structure is guided with minimal clearance in one of the guide bores and the guide channels of the guide portion of the guide device arranged adjacent to the locking rail.

22. The arrester device of claim 13, wherein the thread structure consists of a fine-pitch thread.

23. The arrester device of claim 13, wherein the thread structure comprises additional grooves extending in a longitudinal direction of the shaft.

24. The arrester device of claim 23, wherein the grooves are provided periodically on the thread structure.
